(19) United States
(12) Patent Application Publication
(10) Pub. No.: US 2026/0297354 A1
(43) Pub. Date: Oct. 1, 2026

(54) UNSATURATED TRITHIOCYANURATE DERIVATIVES FOR CURABLE HIGH REFRACTIVE INDEX COMPOSITIONS, ARTICLES THEREOF, AND METHODS OF MAKING SUCH ARTICLES

(71) Applicant: 3M INNOVATIVE PROPERTIES COMPANY, St. Paul, MN (US)

(72) Inventors: Kevin M. Lewandowski, Inver Grove Heights, MN (US); Claire Hartmann-Thompson, Lake Elmo, MN (US); Evan L. Schwartz, Vadnais Heights, MN (US)

(21) Appl. No.: 19/489,003

(22) PCT Filed: Jul. 29, 2024
(86) PCT No.: PCT/IB2024/057320

§ 371 Date: Dec. 1, 2025

Related U.S. Application Data
(60) Provisional application No. 63/518,943, filed on Aug. 11, 2023.

(51) Int. Cl. C09D 11/34

(52) U.S. Cl. CPC C09D 11/34

(57) ABSTRACT

Described herein is a curable ink composition derived from at least one unsaturated trithiocyanurate derivative according to formula (I) wherein R¹, R², and R³ each independently comprise a terminal alkylene or a terminal alkyne; and at least one multifunctional thiol, wherein the curable ink composition is substantially free of solvent. These curable ink compositions can be inkjet printable and when cured have a refractive index of at least 1.70 (when measured at 450 nm).

### TECHNICAL FIELD

Disclosed herein are unsaturated trithiocyanurate derivatives reacted in a thiol-ene and/or thiol-yne reaction to achieve compositions having a high refractive index. Curable compositions and articles using such compositions in, for example, optical devices, are disclosed.

### SUMMARY

In the display industry, a series of alternating organic and inorganic layers (referred to as thin film encapsulation, TFE) may be used onto top of an optical display such as an organic light emitting device (OLED) or quantum dot film, to protect the underlying display and enhance the performance of the display, such as, for example, providing a flexible panel. However, these layers must perform a variety of functions including acting as a barrier to protect the underlying optical display from the external environment (such as moisture and air) and minimizing deleterious optical properties.

In thin film encapsulation, the function of the inorganic layers is to block the ingress of air and moisture into the underlying optical device. The functions of the organic layers are twofold: 1) to planarize the substrate and present a smooth interface for the deposition of the inorganic layer; and 2) to decouple any defects (pinholes, micro-cracks) that may occur in the inorganic layers on either side of the organic layer. The organic layer can be thought of as a buffer layer that is critical for the success of the inorganic layer barrier function.

There is a desire to identify curable compositions with low viscosities that could be ink jet printable and result in an organic layer having a high refractive index.

In one aspect, a curable ink composition is described comprising:
at least one unsaturated trithiocyanurate derivative according to formula (I)

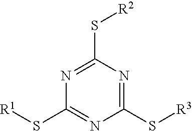

wherein R¹, R², and R³ each independently comprise a terminal alkylene or a terminal alkyne; and
at least one multifunctional thiol, wherein the multifunctional thiol is an aromatic thiol or is a non-aromatic thiol having a liquid refractive index of at least 1.62,
wherein the curable ink composition is substantially free of solvent.

In another aspect, an article is disclosed. The article comprises (i) a substrate with a first major surface and a second major surface; (ii) a cured organic layer adjacent to at least a portion of the second major surface of the substrate, wherein the cured organic layer is derived from at least one unsaturated trithiocyanurate derivative according to formula (I)

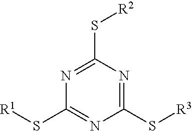

wherein R¹, R², and R³ each independently comprise a terminal alkylene or a terminal alkyne; and
at least one multifunctional thiol; and
(iii) an inorganic barrier layer in contact with the cured organic layer, wherein the cured organic layer has a refractive index of at least 1.70 measured at 450 nm.

In yet another aspect, a method of preparing an article is described. The method comprising:
providing a substrate with a first major surface and a second major surface;
providing a curable ink composition comprising at least one unsaturated trithiocyanurate derivative according to formula (I)

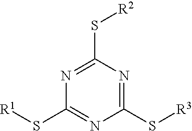

wherein R¹, R², and R³ each independently comprise a terminal alkylene or a terminal alkyne; and at least one multifunctional thiol;
disposing the curable ink composition on at least a portion of the second major surface of the substrate to form a curable layer;
curing the curable layer to form a cured organic layer, wherein the cured organic layer has a refractive index of at least 1.70 measured at 450 nm; and
depositing an inorganic barrier layer on the cured organic layer.

The above summary is not intended to describe each embodiment. The details of one or more embodiments of the invention are also set forth in the description below. Other features, objects, and advantages will be apparent from the description and from the claims.

### BRIEF DESCRIPTION OF DRAWINGS

The present application may be more completely understood in consideration of the following detailed description of various embodiments of the disclosure in connection with the accompanying drawings.

FIG. 1 shows a cross-sectional view of an embodiment of an article of this disclosure.

FIG. 2 shows a cross-sectional view of an embodiment of another article of this disclosure.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

As used herein, the term
“a”, “an”, and “the” are used interchangeably and mean one or more; and
“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The terms “room temperature” and “ambient temperature” are used interchangeably and have their conventional meaning, referring to temperatures of from 20-25° C.

As used herein, the term “adjacent” refers to two layers that are proximate to another layer. Layers that are adjacent may be in direct contact with each other, or there may be an intervening layer. There is no empty space between layers that are adjacent.

As used herein, “comprises at least one of” A, B, and C refers to element A by itself, element B by itself, element C by itself, A and B, A and C, B and C, and a combination of all three.

In the present disclosure, it has been found that a low viscosity, curable composition comprising an unsaturated trithiocyanurate derivative and a multifunctional thiol can result in cured compositions having a high index of refraction and optionally, high glass transition temperatures (Tg).

The curable compositions of the present disclosure are substantially free of solvent and comprise at least one multifunctional thiol and at least one unsaturated trithiocyanurate derivative according to formula (I).

The compound according to formula (I) is

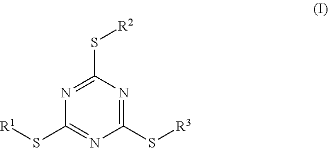

wherein R¹, R², and R³ are independently comprise a terminal carbon-carbon double bond (i.e., monovalent alkylene) or a terminal carbon-carbon triple bond (i.e., monovalent alkyne). Exemplary monovalent alkylenes include: —CH₂CH═CH₂, —CH₂CH₂CH═CH₂, —CH₂CH₂CH₂CH═CH₂, —CH₂CCH₃═CH₂, and —CH₂(phenyl)CH═CH₂, when phenyl is a divalent 6-membered aromatic ring. Exemplary monovalent alkynes include: —CH₂C≡CH, —CH₂CH₂C≡CH, —CH₂CH₂C≡CH, —CH₂CH₂CH₂C≡CH, and —CH₂(phenyl)C≡CH. In some embodiments, R¹, R², and R³ are the same, while in other embodiments, R¹, R², and R³ are different. Exemplary unsaturated trithiocyanurate derivatives according to formula (I) include

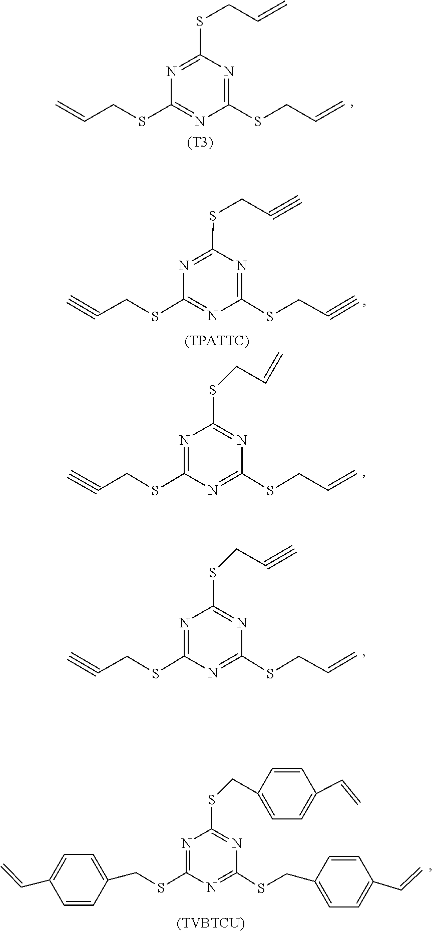

and mixtures thereof.

The multifunctional thiols of the present disclosure comprise at least two thiol (i.e., —SH) groups, although they may have more than 2 thiol groups, for example 3, 4, or even 5 thiol groups. The multifunctional thiols of the present disclosure either comprise an aromatic group or are a non-aromatic thiol. In some embodiments, the multifunctional thiols are liquids at ambient conditions, in other words, room temperature and 1 atmosphere. In some embodiments, the multifunctional thiols of the present disclosure have a melting point below 80, 70, 60, 50, 40, or even 30° C. at ambient pressure (e.g., 760 mm Hg).

In some embodiments, the multifunctional thiol is a non-aromatic thiol, which has a liquid refractive index of at least 1.620, 1.625, 1.630, 1.635, 1.640, 1.650, 1.655, or even 1.660 as determined with a white light refractometer. Generally, the refractive indices of the non-aromatic multifunctional thiols do not go above 1.71 or even 1.70. Exemplary non-aromatic multifunctional thiols, which may have refractive indices of at least 1.620 include: 4-mercaptomethyl-1,8-dimercapt-3,6-dithiaoctane; 5,7-dimercaptomethyl-1,11-dimercapto-3,6, 9-trithiaundecane; 4, 8-dimercaptomethyl-1, 11-dimercapto-3,6,9-trithiaundecane; and 4,7-dimercaptomethyl-1,11-dimercapto-3,6,9-trithiaundecane. Other non-aromatic multifunctional thiols include: poly(ethylene glycol) dithiol; 1,2,3-trimercaptopropane; 2,3-bis-2-mercaptoethylthio-1-propanethiol; 1,2-ethanedithiol; 2,2′-thiodiethanethiol; bi(mercaptoethyl)sulfide; 2,5-bis(mercaptomethyl)-1,4-dithiane; tetra(ethylene glycol) dithiol; 2,2′-(ethylenedioxy)diethanethiol;

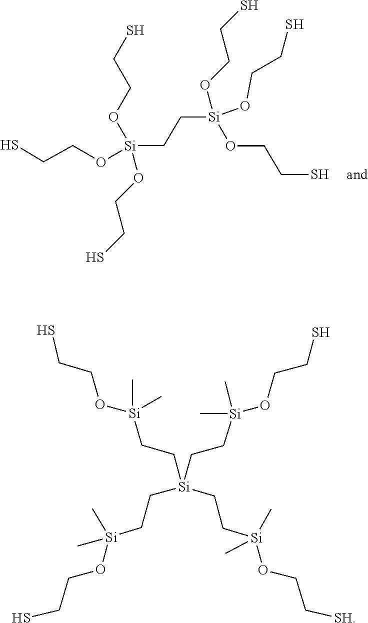 [SMILES: SCCO[Si](CC[Si](OCCS)(OCCS)OCCS)(OCCS)OCCS ; "and" ; C[Si](C)(CC[Si](CC[Si](C)(C)OCCS)(CC[Si](C)(C)OCCS)CC[Si](C)(C)OCCS)OCCS]

Most, if not all, of the latter non-aromatic multifunctional thiols have a liquid refractive index less than 1.620, however, these non-aromatic multifunctional thiols may be used in addition to non-aromatic multifunctional thiols having a refractive index of at least 1.620 and/or aromatic multifunctional thiols to assist with solubility of the components in the curable composition. However, care should be taken to minimize the amount of these lower refractive index materials so as to maintain the high refractive index of the finished product.

In some embodiments, the multifunctional thiol is an aromatic thiol. Aromatic thiols can have high refractive indices, helping to generate a cured composition having a high refractive index. Exemplary aromatic multifunctional thiols include: 1,3-benzenedithiol; toluenedithiol, 1,3-benzenedimethanethiol; 1,3,4-thiadiazole-2.5-dithiol, (1,24) thiadiazole-3,5-dithiol, 1,3,5-trimercaptobenzene, 2-thiazoline-2-thiol, 1,1′,4′,1″-Terphenyl-4-thiol, 5-bromopyridine-2-thiol, biphenyl-4-thiol, 1,7-napthalenedithiol, and 1,5-napthalenedithiol.

The unsaturated trithiocyanurate derivatives and multifunctional thiols described above react in a so-called thiol-ene or thiol-yne reaction depending on if an alkylene or an alkyne is in the unsaturated trithiocyanurate derivative. Typically, the unsaturated trithiocyanurate derivatives and the multifunctional thiol derivatives are reacted using sufficient amounts to ensure an absence of reactive groups remaining in the cured product. A terminal double bond reacts with one thiol, where as a terminal alkyne reacts with 2 thiols. Thus, ideally, there should be a mole ratio of terminal double bonds in Formula (I) to thiol groups in the multifunctional thiol compound of 1:1, and in the case of the triple bonds in Formula (I), there should be a mole ratio of a terminal alkyne bond to thoil group of 1:2. In some embodiments, the mole ratio of terminal C—C double bonds in Formula (I) to thiols (—SH) in the multifunctional thiol compound is 0.8:1 to 1:0.8 or even 0.9:1 to 1:0.9. In some embodiments, the mole ratio of terminal C—C triple bonds in Formula (I) to thiols in the multifunctional thiol compound is 1.6:1 to 2:0.8 or even 1.8:1 to 2:0.9.

In some embodiments, the thiol-ene and thiol-yne reactions in the curable compositions of the present disclosure, consist or consist essentially of the unsaturated trithiocyanurate derivatives according to formula (I) as the reactant providing the unsaturated (i.e., -ene and/or -yne) groups. Thus, in additional to multifunctional thiols, the curable compositions of the present disclosure may be substantially free (for example, comprise less than 5, 2, 1, 0.5 or even 0.1% by weight or even free of) of any monomers comprising at least two terminal unsaturation groups besides those monomers according to Formula (I).

When making the curable composition, the composition is substantially free of solvents. As used herein, “substantially free of solvents” refers to the curable compositions having less than 5, 4, 3, 2, 1, or even 0.5 wt % of non-polymerizable (e.g., organic) solvent. The concentration of solvent can be determined by known methods, such as gas chromatography (for example as described in ASTM D5403-93). It should be noted that whether the curable composition is substantially solvent free or solvent free, no solvent is deliberately added to the composition. The term “solvents” is used herein consistent with the generally understood term of art and encompassing volatile organic and non-organic materials that are liquids at room temperature.

In some embodiments, the curable composition comprises at least one free radical initiator. Typically, the initiator is a photoinitiator, meaning that the initiator is activated by light, generally ultraviolet (UV) light, although other light sources could be used with the appropriate choice of initiator, such as visible light initiators, infrared light initiators, and the like. Thus, the curable compositions are generally curable by UV or visible light, typically UV light. Photoinitiators are known in the art. Examples of suitable free radical photoinitiators include OMNIRAD 4265, OMNIRAD 184, OMNIRAD 651, OMNIRAD 1173, OMNIRAD 819, OMNIRAD TPO, OMNIRAD TPO-L, commercially available from IGM Resins, Charlotte, NC. Particularly suitable photoinitiators include those that feature high absorbance above 365 nm wavelength. These include the acylphosphine oxide family of photoinitiators such as OMNIRAD TPO, OMNIRAD TPO-L, and OMNIRAD 819.

If an initiator is used, generally, the initiator is used in amounts of 0.01 to 10 parts by weight, more typically 0.1 to 2.0 parts by weight relative to 100 parts by weight of total reactive components (i.e., thiols, -enes, and -ynes) in the curable composition.

In some embodiments, the curable composition may include additional optional non-curable components, as long as such components do not interfere with curing of the curable composition and do not adversely affect the properties of the cured composition. The curable compositions may also contain polymerization inhibitors, UV absorbers, light stabilizers (e.g. hindered amine light stabilizers (HALS)), adhesion promoters, sensitizers, synergists, antioxidants, catalysts, dispersants, desiccants, surfactants, leveling agents, and the like as needed or desired.

One particularly suitable optional additive to the curable compositions of the present disclosure is an adhesion promoter. An adhesion promoter is used as an additive or as a primer to promote adhesion between the cured composition and adjacent layers. Among the suitable adhesion promoters are silane-functional compounds, titanates, and zirconates. Examples of suitable titanates and zirconates include titanium or zirconium butoxide. Typically, if used, the adhesion promoter comprises a silane-functional compound. Sometimes silane-functional adhesion promoters are called coupling agents since they have different functionality at each end of the compound and thus can act to couple different surfaces such as inorganic surfaces and organic surfaces. Examples of silane adhesion promoters include a (meth)acrylate-functional alkoxy silane SILQUEST A-174 from Momentive Performance Materials, octadecyltrimethoxysilane, isooctyltrimethoxysilane, hexadecyltrimethoxysilane, hexyltrimethoxysilane, methyl trimethoxysilane, hexamethyldisilazane, hexamethyldisiloxane, aminopropyltrimethoxysilane, 3-acryloxypropyltrimethoxysilane and the like.

In some embodiments, the curable composition further comprises an polymerization inhibitor and/or thermal stabilizer. Generally, these polymerization inhibitors and/or thermal stabilizers are added to the curable composition at an amount of 1 mM to 1 M. Exemplary inhibitors include BHT (2,6-di-t-butyl-p-cresol), MEHQ (4-methoxyphenol), and pyrogallol. Exemplary thermal stabilizers include (4-methoxyphenol, pyrogallol, or 4-tert-butyl-1,2-dihydroxybenzene. Acidic compounds can also be used as co-stabilizers, including benzoic acid, benzenesulfonic acid, phenylphosphonic acid, and vinylphosphonic acid. The typical concentration of the co-stabilizer in the curable composition ranges from 1 mM to 1M. Useful antioxidants include but are not limited to amines, such as N—N′ di-ß-naphthyl-1,4-phenylenediamine, available as “AGERITE D”; phenolics, such as 2,5-di-(t-amyl) hydroquinone, available as “SANTOVAR A”, available from Monsanto Chemical Co., tetrakis[methylene 3-(3′,5′-di-tert-butyl-4′-hydroxyphenyl)propianate]methane, available as “IRGANOX 1010” from Ciba-Geigy Corp., and 2-2′-methylenebis(4-methyl-6-tert butyl phenol), available as Antioxidant 2246; and dithiocarbamates, such as zinc dithiodibutyl carbamate.

Advantageously, the unsaturated trithiocyanurate derivatives according to formula (I) have a high refractive index, which, when used with a high refractive index multifunctional thiol, result in curable composition and ultimately a cured product that has a higher refractive index. In some embodiments, the curable composition has a refractive index of at least 1.630 when measured by refractometry, for example, ASTM D1218-21.

In some embodiments, the curable compositions have a viscosity of 30 centipoise (cP) or less at temperatures from room temperature to about 60° C. In some embodiments, the curable compositions have a viscosity at room temperature of at least 1, 2, 3, 4, or even 5 cp; and at most 30, 25, 20, 15, or even 10 cP. In some embodiments, the curable compositions have a viscosity at 35° C. of at least 1, 2, 3, 4, or even 5 cp; and at most 30, 25, 20, 15, or even 10 cP. In some embodiments, the curable compositions have a viscosity at 60° C. of at least 1, 2, 3, 4, or even 5 cp; and at most 30, 25, 20, 15, or even 10 cP as measured by a viscometer at ambient conditions. For example, the viscosity may be measured by taking 17 mL of the curable composition and loaded it into a 25 mm diameter double gap coaxial concentric cylinder apparatus on a viscometer (BOHLIN VISCO 88, Malvern Instruments Ltd, Malvern, UK). Water, heated to 25° C. can be recirculated in a thermal jacket on the double gap cell of the viscometer to maintain a constant temperature during testing. For example, the system can be equilibrated for 30 minutes prior to taking each measurement. The shear rate may be ramped from 100 to 1000 Hz at 100 hz intervals, and measurements repeated three times to determine the average viscosity.

The curable compositions may be deposited onto a surface using techniques known in the art, including conventional coating techniques, such as bar, roll, curtain, rotogravure, spray, or dip coating techniques. The curable compositions disclosed herein may be especially useful as the organic layer in thin film encapsulation parts. Often, printing techniques, such as inkjet printing are used to deposit these organic layers.

A wide variety of substrates are suitable for the articles of this disclosure. Suitable substrates include a wide array of flexible and non-flexible substrates. For example, the substrate may be glass or a relatively thick layer of a polymeric material such as PMMA (polymethyl methacrylate) or PC (polycarbonate). Alternatively, the substrate may be flexible polymeric film such as films of PET (polyethylene terephthalate), PEN (polyethylene naphthalate), PC (polycarbonate), polyimide, PEEK (polyetherether ketone), and the like. In some embodiments, the substrate comprises a thermally sensitive substrate. A wide variety of thermally sensitive substrates are suitable, for example, an OLED panel.

The curable compositions can be exposed to thermal or photo radiation to initiate the reaction of the thiols with the carbon-carbon double or triple bonds of Formula (I), resulting in a cured composition. The curable composition can be exposed to ultraviolet radiation having an ultraviolet (UV) A maximum in a range of 280 to 425 nanometers. Ultraviolet light sources can be of various types. Low light intensity lights such as blacklights, generally provide intensities ranging from 0.1 or 0.5 mW/cm2 (milliWatts per square centimeter) to 10 mW/cm2 (as measured in accordance with procedures approved by the United States National Institute of Standards and Technology as, for example, with a UVIMAP UM 365 L-S radiometer manufactured by Electronic Instrumentation & Technology, Inc., in Sterling, VA). High light intensity sources generally provide intensities greater than 10, 15, or 20 mW/cm2 ranging up to 450 mW/cm2 or greater. In some embodiments, high intensity light sources provide intensities up to 500, 600, 700, 800, 900 or 1000 mW/cm2. UV light to polymerize the monomer component(s) can be provided by various light sources such as light emitting diodes (LEDs), blacklights, medium pressure mercury lamps, etc. or a combination thereof. The reagents can also be polymerized with higher intensity light sources as available from Fusion UV Systems Inc. The UV exposure time for polymerization and curing can vary depending on the intensity of the light source(s) used. For example, complete curing with a low intensity light course can be accomplished with an exposure time ranging from about 30 to 300 seconds; whereas complete curing with a high intensity light source can be accomplished with shorter exposure time ranging from about 5 to 20 seconds. Partial curing with a high intensity light source can typically be accomplished with exposure times ranging from about 2 seconds to about 5 or 10 seconds.

In some embodiments, it is preferable to use lights that emit a narrow spectrum of light in the ultraviolet region of the electromagnetic spectrum. These light sources, which can include LEDs and lasers, can result in the formation of cured compositions without the need to add conventional initiators prior to the curing process. These light sources can enhance the rate of polymerization, while maintaining the living nature of the polymeric material.

In other embodiments, where broader wavelength ultraviolet light sources are used such as blacklights, conventional photoinitiators may need to be added to the curable compositions prior to crosslinking.

Generally, this cured layer has a refractive index of at least 1.700, 1.710. 1.720, 1.730, 1.740, 1.750, 1.760, 1.770, or even 1.780 when measured at 450 nm. High index nanoparticles, such as polymeric, metal, or metal oxide particles having a refractive index of at least 1.6 are typically used to increase the refractive index of the cured layer. However, advantageously, the cured compositions of the present disclosure have a high refractive index without the use of nanoparticles.

In some embodiments, the cured composition has a glass transition temperature of at least 10, 20, 30, 40, 45, 50 or even 54° C. and at most 120, 110, 100, 90, or even 80° C. The terms “Tg” and “glass transition temperature” are used interchangeably. If measured, Tg values are determined by Differential Scanning Calorimetry (DSC) at a scan rate of 10° C./minute, unless otherwise indicated.

Ideally, the cured composition is optically clear. Unless otherwise indicated, “optically clear” refers to a layer, film, or article that has a high light transmittance over at least a portion of the visible light spectrum (about 400 to about 700 nm), and that exhibits low haze. Typically, optically clear layers, films, or articles have visible light transmittance values of at least 85%, or even 90%, often at least 95%, and haze values of 5% or less, often 2% or less using a technique such as ASTM D1003-21.

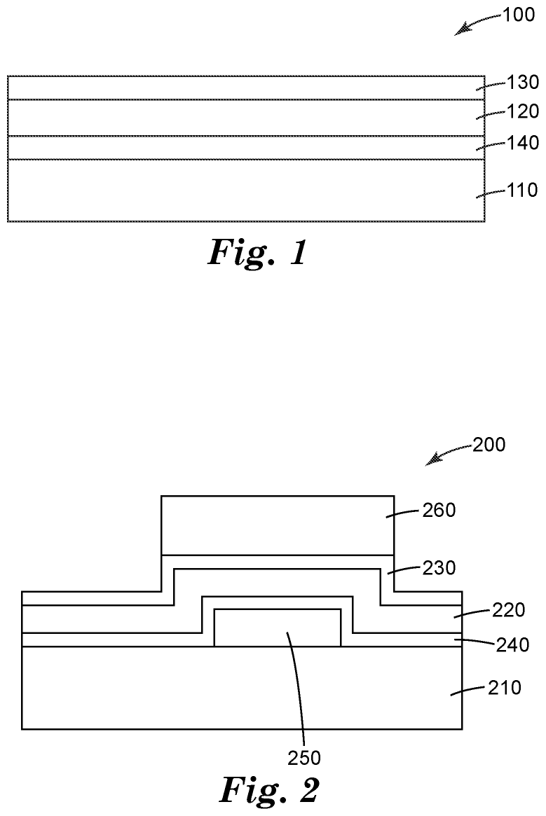

Also disclosed herein are articles. A wide variety of articles may be prepared utilizing the curable compositions described above. The articles may be relatively simple articles such as a substrate with a layer of cured composition disposed on it as shown in FIG. 1, where article 100 comprises substrate 120 with cured organic layer 110 disposed on the substrate. Substrate 120 includes a wide array of flexible and non-flexible substrates. For example, substrate 120 may be glass, silicone nitride, silicon oxynitride, or a relatively thick layer of a polymeric material such as PMMA (polymethyl methacrylate) or PC (polycarbonate). Alternatively, substrate 120 may be flexible polymeric film such as films of PET (polyethylene terephthalate), PEN (polyethylene naphthalate), PC (polycarbonate), polyimide, PEEK (polyetherether ketone), and the like. Cured organic layer 110 is the cured layer derived from the curable compositions described herein. In some embodiments, the cured organic layer has a thickness of from 1-50 micrometers, in some embodiments from 5-30 micrometers.

In other embodiments, the articles are more complex, such as multilayer articles comprising a substrate, and an inorganic barrier layer, with a cured organic layer between them, where the cured layer functions as a decoupling layer. The substrate may optionally have an inorganic coating layer present on its surface, so that the cured organic layer may be in contact with substrate surface or with the optional inorganic coating layer.

In some embodiments, the articles comprise a substrate with a first major surface and a second major surface, a cured organic layer with a first major surface and a second major surface, where the first major surface of the cured organic layer is adjacent to at least a portion of the second major surface of the substrate.

FIG. 2 shows a device that includes a multilayer article of the present disclosure. FIG. 2 shows article 200 comprising substrate 230 with device 240 disposed on substrate 230. Inorganic barrier layer 250 is in contact with device 240 and cured organic layer 210 is in contact with the inorganic barrier layer 250. FIG. 2 also includes optional inorganic layer 260 that is in contact with cured organic layer 210. Optional layer 270 is in contact with optional inorganic layer 260 and also with substrate 280. Additionally, between optional layer 260 and optional layer 270, there may be optional alternating pairs of layers of cured organic (210) and inorganic (260) layers. For clarity these optional layers are not shown, but one can readily envision a stack of layers in the sequence 250/210/260/210/260, or 250/210/260/210/260/210/260, and so on.

The curable compositions disclosed herein can be cured and find use as an organic layer in a thin film encapsulation part. These organic layers should be deposited onto surfaces in a precise and consistent manner, which is usually done using printing techniques. In printing techniques, the curable composition that upon curing forms a polymer, is printed onto a substrate surface to form a layer. A wide variety of printing techniques can be used, with inkjet printing being particularly desirable because of the excellent precision of inkjet printing. Because the curable compositions may be printable, they may be herein also referred to as inks. The curable compositions need not be used as inks, that is to say that they need not be printed and then cured, the curable compositions can be delivered to substrate surfaces in a wide variety of ways, but they are capable of being printed. In particular, the printable compositions of this disclosure are typically capable of being inkjet printed, which means that they have the proper viscosity and other attributes required to be inkjet printed. The term “inkjet printable” is not a process description or limitation, but rather is a material description, meaning that the curable compositions are capable of being inkjet printed, and not that the compositions necessarily have been inkjet printed. In this disclosure, curable compositions, which may be considered “inks”, that are capable of being printed, are described which have a number of traits that make them suitable for the formation of layers within multilayer optical devices. As mentioned above, the curable compositions of the present disclosure are substantially free of solvent, which is advantageous as drying coating to remove solvent can not only decrease the thickness of the layer, but also adversely affect the surface smoothness and may also create defects in the coating. In many applications for optical devices, it is desired that the coatings be precise, that is to say that they do not lose thickness or smoothness upon drying. Therefore, the curable compositions of the present disclosure are preferably “100% solids”, meaning that they do not contain volatile solvents and that all of the mass that is deposited on a surface remains there, no volatile mass is lost from the coating.

The thickness of the cured composition is limited by the application used. For thin film encapsulation products, typically the cured organic layer has a thickness of from 1-50 micrometers, in some embodiments from 5-30 micrometers. Additionally, in many embodiments, the cured organic layer has a surface roughness of less than or equal to 10 nanometers, in some embodiments less than or equal to 5 nanometers.

An example of an optical device that utilizes thin film layers are OLED (organic light-emitting diode) devices. In particular, the organic light-emitting devices are susceptible to degradation from the permeation of certain liquids and gases, such as water vapor and oxygen. To reduce permeability to these liquids and gases, barrier coatings are applied to the OLED device. Typically, these barrier coatings are not used alone, rather a barrier stack is used which can include multiple dyads. Dyads are two-layer structures that include a barrier layer (i.e., inorganic layer) and decoupling layer (i.e., organic layer). The decoupling layer provides a planarized and/or smooth surface for the deposition of the inorganic barrier layer.

The inorganic barrier layer 250 in contact with cured organic layer 210 can be prepared from a variety of materials including metals, metal oxides, metal nitrides, metal oxynitrides, metal carbides, metal oxyborides, and combinations thereof. A wide range of metals are suitable for use in the metal oxides, metal nitrides, and metal oxynitrides, particularly suitable metals include Al, Zr, Si, Zn, Sn, and Ti. One particularly suitable inorganic barrier layer material is silicon nitride.

The thickness of the inorganic barrier layer 250 is not particularly limited, generally it is between 20 nanometers and 1 micrometer (1000 nanometers). More typically the thickness is from 20 nanometers to 100 nanometers.

Optional inorganic barrier layer 260 is of a similar thickness as inorganic barrier layer 250 and may comprise the same inorganic material, or it may be a different inorganic material.

One embodiment of the device 200 is a touch sensing device. In this device, substrate 230 is a thin film transistor, device 240 is an OLED device, optional layer 270 is an optically clear adhesive layer, and substrate 280 is a touch sensor.

In some embodiments, the curable composition is disclosed onto the surface of a substrate and then cured to form a cured organic layer. In some embodiments, an inorganic barrier layer is disposed onto the exposed surface of the cured organic layer.

In some embodiments, the curable composition can be printed and then cured to form a layer. In some embodiments, the cured composition has a thickness of from 1-16 micrometers, and a surface roughness of less than or equal to 5 nanometers. In many embodiments, the disposing of the curable composition on the second major surface of the substrate to form a curable layer comprises printing, especially inkjet printing. As described above, inkjet printing has a variety of desirable features that make it particularly suitable for preparing the curable layer, including the ability to deposit precise patterns on complex substrates and form a uniform coating with low surface roughness that is less than 10 nanometers, in some embodiments less than or equal to 5 nanometers.

In some embodiments, the article further comprises a device disposed on the second major surface of the substrate, and adjacent to the cured organic layer.

In some embodiments, the substrate comprises an inorganic coating layer present on the second major surface, such that the first major surface of the cured organic layer is in contact with the inorganic coating layer.

The above-described constructions can also be used as components of more complex articles. In some embodiments, the article further comprises a device disposed on the second major surface of the substrate, and adjacent to the first major surface of the cured organic layer. In some embodiments, an inorganic coating layer is disposed on the device and on the second major surface of the substrate, such that the first major surface of the cured organic layer is in contact with the inorganic coating layer. In some specific embodiments, the device comprises an OLED (organic light-emitting diode).

### EXAMPLES

Unless otherwise noted, all pans, percentages, ratios, etc. in the examples and the rest ofthe specification are by weight, and all reagents used in the examples were obtained, or are available, from general chemical suppliers such as, for example, Millipore-Sigma Company, Saint Louis, Missouri, or may be synthesized by conventional methods.

TABLE 1
Materials List

| DESIGNATION | DESCRIPTION |
|---|---|
| 1,3,5-triazine- | Available from Oakwood Chemical |
| 2,4,6-trithione | (Estill, SC) |
| Allyl bromide | Available from Oakwood Chemical |
| Propargyl | Available from Oakwood Chemical |
| bromide | |
| Chloromethyl | Available from TCI Chemicals |
| styrene | (Portland, OR) |
| M1 | Biphenyl methyl acrylate, available |
| | under the trade designation “MIRAMER |
| | M1192HP” from Miwon (Exton, PA) |
| M2 | Modified bisphenol fluorene diacrylate, |
| | available under the trade designation |
| | “MIRAMER HR6060” from Miwon |
| T3 | Triallyl trithiocyanurate, see synthesis |
| TPATTC | Tripropargyl trithiocyanurate, see synthesis |
| Mixed TA/P | Mixed tris allyl/propargyl thiocyanurate, |
| TCU | see synthesis |
| TVBTCU | Tri(vinylbenzyl)thiocyanurate, see synthesis |
| Si(vinyl)4 | Tetravinylsilane, available from Millipore-Sigma |
| | (Milwaukee, WI) |
| Si(allyl)4 | Tetraallylsilane, available from Gelest |
| | (Morristown, PA) |
| TAIC | Triallyl isocyanurate, available from TCI |
| | Chemicals (Portland, OR) |
| TVCH | 1,2,4-Trivinylcyclohexane, available from |
| | TCI Chemicals |
| 13BDT | 1,3-Benzenedithiol, available from TCI |
| | Chemicals, reported refractive index |
| | of 1.662 |
| 13BDMT | 1,3-Benzenedimethanethiol, available |
| | from TCI Chemicals, reported |
| | refractive index of 1.621 |
| DMPT | 2,3-Bis((2-mercaptoethyl)thio)-1-propanethiol, |
| | available as “THIOCURE DMPT” from |
| | Bruno Bock GMBH, Marschact, Germany, |
| | reported refractive index of 1.630 |
| PETMP | Pentaerythritol terakis(3-mercaptopropionate), |
| | available from Millipore |
| | Sigma, reported refractive index of 1.531 |
| TPO-L | 2,4,6-Trimethylbenzoylphenyl-phosphinic |
| | acid ethyl ester, available under |
| | the trade designation “”OMNIRAD TPO—L” |
| | from BASF (Florham Park, NJ) |

### Preparation of T3

To a solution of water (30 mL) and potassium hydroxide (10.13 g, 0.18 mol), ethanol (130 mL) was added. While cooling in a water bath, 1,3,5-triazine-2,4,6-trithione (10.00 g, 0.056 mol) was added slowly over five minutes. The mixture was stirred for 30 minutes until the solid dissolved. Allyl bromide (27.42 g, 0.23 mol) was then added. The reaction was warmed to 40° C. and was stirred at room temperature for three hours. The mixture was then concentrated under vacuum. Ethyl acetate (150 mL) and water (100 mL) were added, and the organic phase was separated and concentrated under vacuum. The crude product was purified by column chromatography over silica gel (gradient of 0 to 20 vol % ethyl acetate in hexanes). The final product was isolated as slightly greenish/yellow oil (13.514 g).

### Preparation of TPATTC

Solid sodium metal (2.34 g, 0.102 mol) was added to ethanol (120 mL). The mixture was stirred until the solid fully dissolved. 1,3,5-Triazine-2,4,6-trithione (6.00 g, 0.034 mol) was then added in portions over five minutes. The mixture was stirred for thirty minutes until the solid had dissolved. Propargyl bromide (20.00 g of an 80 wt % solution in toluene, 0.134 mol) was then added and the mixture was stirred at room temperature for seventeen hours. The mixture was then concentrated under vacuum. Ethyl acetate (150 mL) and water (100 mL) were added, and the organic phase was separated and concentrated under vacuum. The crude product was purified by column chromatography over silica gel (gradient of 0 to 20% ethyl acetate in hexanes). The final product was isolated as slightly yellow solid (5.27 g).

### Preparation of Mixed Tris Allyl/Propargyl Thiocyanurate (Mixed TA/P TCU)

Solid sodium metal (3.89 g, 0.169 mol) was added to ethanol (130 mL). The mixture was stirred until the solid fully dissolved. 1,3,5-triazine-2,4,6-trithione (10.00 g, 0.056 mol) was then added in portions over five minutes. The mixture was stirred for thirty minutes until the solid had dissolved. A mixture of allyl bromide (7.50 g, 0.062 mol) and propargyl bromide (18.45 g of an 80 wt % solution in toluene, 0.124 mol) was then added and the mixture was stirred at room temperature for three hours. The mixture was then concentrated under vacuum. Ethyl acetate (150 mL) and water (100 mL) were added, and the organic phase was separated and concentrated under vacuum. The crude product was purified by column chromatography over silica gel (gradient of 5 to 30% ethyl acetate in hexanes). The final product was isolated as slightly yellow waxy solid (13.39 g), with overall composition of 32% allyl and 68% propargyl substitution.

### Preparation of Tri(vinylbenzyl)thiocyanurate (TVBTCU)

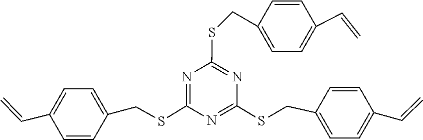 [SMILES: C=Cc1ccc(CSc2nc(SCc3ccc(C=C)cc3)nc(SCc3ccc(C=C)cc3)n2)cc1]

Solid sodium metal (3.11 g, 0.135 mol) was added to ethanol (130 mL). The mixture was stirred until the solid fully dissolved. 1,3,5-Triazine-2,4,6-trithione (8.00 g, 0.045 mol) was then added in portions over five minutes. The mixture was stirred for thirty minutes until the solid had dissolved. Chloromethyl styrene (mixture of p and m isomers, 21.00 g, 0.138 mol) was then added and the mixture was stirred at 50° C. for seventeen hours. The mixture was then concentrated under vacuum. Ethyl acetate (100 mL) and water (100 mL) were added, and the solid product was filtered. The solid product was dissolved in dichloromethane (300 mL) and dried with magnesium sulfate. The mixture was filtered and concentrated under vacuum to give the final product as a tan solid (14.28 g).

### Test Methods

### Refractive Index of Liquid Compositions

The refractive index was measured on a refractometer (Milton Roy Company, Ivyland, PA). The liquid sample was sealed between two prisms and the refractive index was measured at 20° C. at the “white light” 589 nm line of a sodium lamp.

### Refractive Index of Cured Films

Refractive index of the cured ink films on PET substrates was measured using a digital prism coupler (Model 2010, Metricon Inc., Pennington, NJ) at 450 nm at 20° C.

### Differential Scanning Calorimetry (DSC)

DSC samples were prepared for thermal analysis by weighing and loading the material into TA Instruments (New Castle, Delaware) aluminum DSC sample pans. The specimens were analyzed using the TA Instruments Discovery Differential Scanning Calorimeter (DSC—SN DSC1-0091, New Castle, DE) utilizing a heat-cool-heat method in standard mode (−155° C. to about 150° C. at 10° C./minute.). After data collection, the thermal transitions were analyzed using the TA Universal Analysis program. The glass transition temperatures were evaluated using the step change in the standard heat flow (HF) curves. The midpoint (half height) temperature of the second heat transition is reported.

### Examples 1-8 (E1-E8) and Comparative Examples 1-11 (C1-C11)

Thiol-ene/yne formulations were prepared from mixtures of liquid thiols and alkenes/alkynes with mass ratios as shown in Table 2 below. The mass ratios were selected such that the thiol groups were in a one-to-one molar ratio with the alkene groups, and in formulations with alkyne groups, two equivalents of thiol per alkyne group were used. TPO-L was added at 3 wt % to the thiol and the -ene or -yne listed in Table 2 and the formulation was mixed thoroughly. The liquid formulation was cast onto a polyethylene terephthalate (PET) substrate using a Meyer rod (number 10), and UV cured using a UV LED curing system (Clearstone Technologies Inc., Hopkins, MN, 395 nm, 100% intensity corresponding to 319 mW/cm² for 2 minutes at a distance of 1 cm from the surface of the sample). Transparent hardcoats were obtained. The samples were tested for refractive index and glass transition temperature and the results are reported in Table 2.

Comparative Example 12 (C12), methacrylate resin derived from biphenylmethyl acrylate (M) and bisphenol fluorene diacrylate (M2) was prepared following Example 4 in U. S. Pat. Publ. No. 2019/0352520 (Schwartz et al.). The refractive index is reported in Table 2.

TABLE 2

| | | | Glass | |
|---|---|---|---|---|
| | | | Transition | Refractive |
| Sam- | Thiol | -ene or -yne | Temperature | Index |
| ple | (wt %) | (wt %) | (° C.) | (450 nm) |
| C1 | 13BDT (60%) | Si(allyl)4 (40%) | 27 | 1.706 |
| C2 | 13BDT (46%) | TAIC (54%) | 41 | 1.675 |
| C3 | 13BDT (57%) | TVCH (43%) | 14 | 1.682 |
| E1 | 13BDT (42%) | T3 (58%) | 18 | 1.751 |
| E2 | 13BDT (59%) | TPATTC (41%) | 42 | 1.783 |
| E3 | 13BDT (51%) | Mixed TA/P | 48 | 1.779 |
| | | TCU (49%) | | |
| E4 | 13BDT (29%) | TVBTCU (71%) | 23 | 1.700 |
| C4 | 13BDMT (71%) | Si(vinyl)4 (29%) | 30 | 1.688 |
| C5 | 13BDMT (50%) | TAIC (50%) | 25 | 1.644 |
| C6 | 13BDMT (61%) | TVCH (39%) | 11 | 1.648 |
| E5 | 13BDMT (46%) | T3 (54%) | 10 | 1.711 |
| E6 | 13BDMT (63%) | TPATTC (37%) | 39 | 1.732 |
| C7 | DMPT (72%) | Si(vinyl)4 (28%) | −61 | 1.600 |
| C8 | DMPT (62%) | TVCH (38%) | −43 | 1.715 |
| E7 | DMPT (47%) | T3 (53%) | 9 | 1.713 |
| E8 | DMPT (64%) | TPATTC (36%) | 54 | 1.727 |
| C9 | PETMP (78%) | Si(vinyl)4 (22%) | −26 | 1.581 |
| C10 | PETMP (55%) | T3 (45%) | 25 | 1.645 |
| C11 | PETMP (71%) | TPATTC (29%) | 48 | 1.640 |
| | Acrylate | | | |
| | composition | | | |
| C12 | 95/5 M1/M2 | | not tested | 1.657 |

As shown in the table above, in general, T3 raises the refractive index of the cured product versus the comparative samples using the same thiol. TPATTC and Mixed TA/P TCU raises both the refractive index as well as the Tg versus the comparative samples using the same thiol.

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A curable ink composition comprising:
at least one unsaturated trithiocyanurate derivative according to formula (I) 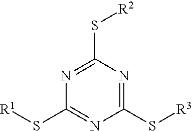
wherein R¹, R², and R³ each independently comprise a terminal alkylene or a terminal alkyne; and
at least one multifunctional thiol, wherein the multifunctional thiol is a non-aromatic thiol having a refractive index of at least 1.620 or is an aromatic thiol;
wherein the curable ink composition is substantially free of solvent.

2. The curable ink composition of claim 1, wherein at least one of R¹, R², or R³ is —CH₂CH═CH₂, —CH₂CH₂CH═CH₂, —CH₂CH₂CH₂CH═CH₂, —CH₂CCH₃═CH₂, or —CH₂(phenyl)CH═CH₂.

3. The curable ink composition of claim 1, wherein at least one of R¹, R², or R³ is —CH₂C≡CH, —CH₂CH₂C≡CH, —CH₂CH₂CH₂C≡CH, or —CH₂(phenyl)C≡CH.

4. The curable ink composition of claim 1, wherein at least one of R¹, R², or R³ comprises a terminal alkyne.

5. The curable ink composition of claim 1, wherein the ratio of thiol groups to the terminal alkylene is 1:0.8 to 0.8:1.

6. The curable ink composition of claim 1, wherein the ratio of thiol groups to the terminal alkyne is 2:0.8 to 1.6:1.

7. The curable ink composition of claim 1, wherein the trithiocyanurate derivative according to formula (I) is: 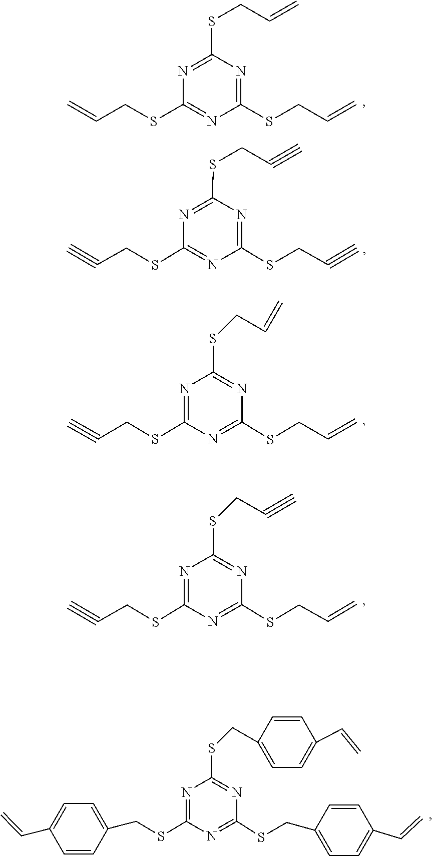
or mixtures thereof.

8. The curable ink composition of claim 1, wherein the multifunctional thiol is an aromatic thiol.

9. The curable ink composition of claim 1, wherein the multifunctional thiol is 4-mercaptomethyl-1,8-dimercapt-3,6-dithiaoctane; 5,7-dimercaptomethyl-1,11-dimercapto-3,6, 9-trithiaundecane; 4, 8-dimercaptomethyl-1, I1-dimercapto-3,6,9-trithiaundecane; 4,7-dimercaptomethyl-1,11-dimercapto-3,6,9-trithiaundecane, or mixtures thereof.

10. The curable ink composition of claim 1, wherein, apart from the unsaturated trithiocyanurate derivative according to formula (I), the curable ink composition is substantially free of another monomer comprising at least two terminal unsaturated groups, wherein the terminal unsaturated groups are selected from C—C double bonds and C—C triple bonds.

11. (canceled)

12. The curable ink composition of claim 1, wherein the curable ink composition has a liquid refractive index of at least 1.630.

13. The curable ink composition of claim 1, wherein the curable ink composition further comprises an inhibitor.

14. The curable ink composition of claim 1, wherein the curable ink composition further comprises a thermal stabilizer.

15. (canceled)

16. The curable ink composition of claim 1, wherein the curable ink composition has a viscosity of 100 cps or less at a temperature of from room temperature to 35° C.

17. An article comprising:
a substrate with a first major surface and a second major surface;
a cured organic layer adjacent to at least a portion of the second major surface of the substrate, wherein the cured organic layer is derived from at least one unsaturated trithiocyanurate derivative according to formula (I) 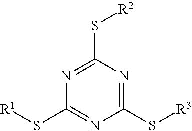
wherein R¹, R², and R³ each independently comprise a terminal alkylene or a terminal alkyne; and at least one multifunctional thiol; and
an inorganic barrier layer in contact with the cured organic layer, wherein the cured organic layer has a refractive index of at least 1.700 (measured at 450 nm).

18. The article according to claim 17, wherein the cured organic layer is optically clear.

19. The article according to claim 17, wherein the cured organic layer has a glass transition temperature of at least 10° C.

20. The article according to claim 17, wherein the cured organic layer has a thickness of from 1 to 16 micrometers, and a surface roughness of less than or equal to 5 nanometers.

21. The article according to claim 17, wherein the article further comprises a device disposed on the second major surface of the substrate, and adjacent to the cured organic layer.

22. (canceled)

23. A method of preparing an article comprising:
providing a substrate with a first major surface and a second major surface;
providing a curable ink composition comprising at least one unsaturated trithiocyanurate derivative according to formula (I) 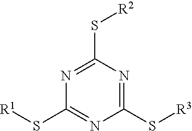
wherein R¹, R², and R³ each independently comprise a terminal alkylene or a terminal alkyne;
and at least one multifunctional thiol,
disposing the curable ink composition on at least a portion of the second major surface of the substrate to form a curable layer;
curing the curable layer to form a cured organic layer, wherein the cured organic layer has a refractive index of at least 1.70 measured at 450 nm; and
depositing an inorganic barrier layer on the cured organic layer.

24. (canceled)

25. (canceled)
